(19) United States
(12) Patent Application Publication
(10) Pub. No.: US 2005/0022164 A1
(43) Pub. Date: Jan. 27, 2005

(54) Systems and methods utilizing a workflow definition language

(75) Inventor: Pal Takacsi-Nagy, Cupertino, CA (US)

Correspondence Address: FLIESLER MEYER, LLP, FOUR EMBARCADERO CENTER, SUITE 400, SAN FRANCISCO, CA, 94111, US

(73) Assignee: BEA Systems, Inc., San Jose, CA (US)

(21) Appl. No.: 10/784,375

(22) Filed: Feb. 23, 2004

Related U.S. Application Data
(60) Provisional application No. 60/450,074, filed on Feb. 25, 2003.

(51) Int. Cl. G06F 9/44

(52) U.S. Cl. 717/117; 717/114

(57) ABSTRACT

An easy-to-use workflow language can be created by extending an existing, common language such as Java. The language can be extended by adding those constructs that are missing but desirable. Such desirable constructs can include parallelism, asynchrony, loops over asynchronous events, and flexible handling of XML. Such constructs can allow a user to define a virtual program using the extended Java syntax. For example, XML can be placed inside a Java class that defines the high-level orchestration logic a workflow should follow. That orchestration logic can refer to the Java class to carry out work, such that the logic to handle an incoming message is really in Java. This description is not intended to be a complete description of, or limit the scope of, the invention. Other features, aspects, and objects of the invention can be obtained from a review of the specification, the figures, and the claims.

### CLAIM OF PRIORITY

This application claims priority to U.S. Provisional Patent Application No. 60/450,074 filed Feb. 25, 2003, entitled “SYSTEMS AND METHODS UTILIZING A WORKFLOW DEFINITION LANGUAGE” (Attorney Docket No. BEAS-01389US0), which is hereby incorporated herein by reference.

### CROSS-REFERENCED CASES

The following applications are cross-referenced and incorporated herein by reference:

U.S. Provisional Patent Application No. 60/376,906 entitled “COLLABORATIVE BUSINESS PLUG-IN FRAMEWORK,” by Mike Blevins, filed May 1, 2002;

U.S. Provisional Patent Application No. 60/377,157 entitled “SYSTEM AND METHOD FOR COLLABORATIVE BUSINESS PLUG-INS” by Mike Blevins, filed May 1, 2002.

U.S. patent application Ser. No. 10/404,552 entitled “COLLABORATIVE BUSINESS PLUG-IN FRAMEWORK,” by Mike Blevins, filed Apr. 01, 2003;

U.S. patent application Ser. No. 10/404,296 entitled “SYSTEMS AND METHODS FOR COLLABORATIVE BUSINESS PLUG-INS” by Mike Blevins, filed Apr. 01, 2003;

U.S. patent application Ser. No. ______ entitled “SYSTEMS AND METHODS FOR EXTENDING AN EXISTING PROGRAMMING LANGUAGE WITH CONSTRUCTS” by Pal Takacsi-Nagy And Michael D. Blow, filed ______ .

### COPYRIGHT NOTICE

A portion of the disclosure of this patent document contains material which is subject to copyright protection. The copyright owner has no objection to the facsimile reproduction by anyone of the patent document of the patent disclosure, as it appears in the Patent and Trademark Office patent file or records, but otherwise reserves all copyright rights whatsoever.

### FIELD OF THE INVENTION

The present invention relates to workflow languages, and to the extension of programming languages.

### BACKGROUND

Many businesses have adopted the concept of workflows to automate, business processes. A workflow generally refers to a software component that is capable of performing a specific set of tasks. These tasks, which can include work items or other workflows, are typically connected in a way that allows the tasks to be ordered upon the completion. In a workflow, information such as files, documents, or tasks are passed between system resources according to a set of procedural rules so that the system can act upon the information.

In order to incorporate and develop workflows, several companies have developed a workflow language (WFL). Many workflow languages are simple, with each component in the WFL having one input and at least one output. The input can accept a token that triggers the component to perform the appropriate task. After completing the task, the component can generate a token that contains the result of the task. This token can be passed to any other component needing to execute a task utilizing that result.

While many of these workflow languages and workflow management systems are currently being used, each typically utilizes some amount of proprietary information. The existing workflow languages attempt to be complete programming languages, and consequently the developers end up reinventing a lot of things that popular programming languages already do. Further, it is necessary for developers to take on the time and expense to learn these new programming languages.

### BRIEF SUMMARY

Systems and methods in accordance with embodiments of the present invention overcome many of the deficiencies in existing workflow languages by simply extending the syntax of an existing and popular programming language that is already familiar to developers. One such workflow language extends the Java programming language.

Other features, aspects, and objects of the invention can be obtained from a review of the specification, the figures, and the claims.

### BRIEF DESCRIPTION OF THE DRAWINGS

FIG. 1 is a diagram of a workflow that can be used in accordance with one embodiment of the present invention.

FIG. 2 shows a workflow language code example for the workflow of FIG. 1.

FIG. 3 shows an example of a Java workflow file that can be used in accordance with embodiments of the present invention.

### DETAILED DESCRIPTION

Systems and methods in accordance with the present invention can take advantage of users' knowledge and preference for existing programming languages by simply extending such a language. People like to use these existing languages because they already know and are familiar with them. For instance, many developers like to use Java because they are familiar with the variables and simple procedure logic. Systems and methods in accordance with the present invention attempt to capitalize on this by simply extending Java with those constructs that are missing but desirable. For instance, such desirable constructs can include parallelism, asynchrony, loops over asynchronous events, and flexible handling of XML. Such constructs can allow a user to define a virtual program using the extended Java syntax. XML can be placed inside a Java class that defines the high-level orchestration logic a workflow should follow. That orchestration logic can refer to the Java class to carry out work, such that the logic to handle an incoming message is really in Java.

Languages such as have constructs such as a “while . . . do” construct and a “for” loop construct, which can each happen in a short period of time with no interruption or pause in execution. Constructs in accordance with embodiments of the present invention can happen over a long period of time, and are not limited to specific time intervals. For example, a user can utilize a loop construct to receive certain messages, but that user will typically have no control over the frequency at which messages are received. In such a situation, a system in accordance with the present invention can be set to allow a user to define a special “for” loop. This special “for” loop allows the system to receive a specified type or class of messages until a specified condition is met. The actual logic to handle the received messages, or to determine that the condition is not validated, can be done using Java in a way that is similar to how a user would use a normal Java program. By using an extended syntax and construct, the user can create such “for” loop without wasting system resources.

Another aspect to such a construct in accordance with embodiments of the present invention is that the construct cannot only execute for a long period of time, but can also “remember” what happens during that time. The construct can allow information to be processed in an efficient manner. Instead of maintaining tens of thousands of little programming objects, dormant programs can be stored away efficiently and then revived when needed. Further, such systems can handle server clusters running virtual programs that can actually “pop-up” on any machine in the cluster, further increasing resource efficiency. It may not be enough to simply revive dormant programs, as it may be necessary to revive a program in the exact state the program was in before going dormant. It can also be desirable to allow a dormant program to be revived in the proper state on any machine in the appropriate cluster.

One implementation of such a workflow language (WFL) includes a Java program with an appropriate extension. In order to provide the ability for an application component go dormant efficiently and then come back at a later time, a light-weight virtual machine can be used for the workflow that is able to save execution space, including the program stack and variable state, and is then able to revive the program.

The looping construct described above is just one example. In another simple example using such a workflow program, a user can write a Java program designating that message A and message B are to be received, followed by message C. If the messages are received in the wrong order, a workflow container can be used to handle the ordering. The container can save later messages until after the earlier messages are received and/or processed. This approach is a simple looping-style example that can be used to add ordering functionality to Java, which does not itself include an efficient order process.

Workflow Annotations

In one embodiment, a workflow can be defined in a Java Web Service (JWS) file, by placing the WFL definition to an annotation of the Java class of the JWS. E.g.:

| | |
|---|---|
| /** | |
| * @jwf:flow flow:: | |
| * | |
| * <process name=“PurchaseOrder”> | |
| * | ... |
| * </process> | |
| * :: | |
| **/ | |
| public class PurchaseOrder {...} | |

The name of the annotation that contains the workflow definition is jwf.flow. The Java methods and variables defined in the JWS file can be referenced by the flow logic.

Process can be the top-level container for workflow logic. A process can be made up of a set of activities with defined ordering. Activities can be simple, like an action or complex, like a loop. Activity types that can be supported can include, for example:
Action—a basic building block used in a workflow, which can allow a workflow to call an operation on a control, call a piece of Java code, or a control to call back the workflow
Various loop types—can execute a set of activities multiple times depending on at least one condition
Parallel—can allow for multiple parallel branches
Switch—can provide a conditional branch in the workflow
multiReceive—can execute input-guarded branching
End—can mark the end of the workflow
   In addition to activities, processes can contain declarations for correlation, transactions and exceptions.

A workflow can use variables that are referred to herein as “workflow variables.” Flow logic can reference variables in actions, conditions and correlations. All workflow variables can be declared in Java, as class variables or fields. There may be no special scoping for workflow variables, as all workflow variables can be “global” to a workflow instance. Workflow variables can be persisted along with the workflow state unless, for example, the variables are marked transient.

A special XML interface can be used to store XML content as XML (i.e. not converting to schema-influenced Java types). E.g.:

XML savedPO;
void getPO (XML po) {
savedPO = po;
}

Workflow variables can be shown on a GUI canvas if the variables are of primitive Java types, e.g. int, Boolean, String etc. or of the XML type. Variables of other types can be still used by Java code inside the Java Work Flow (JWF) file, but may not be displayed on the GUI. The JWF can be a Java class with annotations that describe the flow logic, with the annotations referencing Java or Xquery methods within the class that implement the detailed business logic.

Controls can also be declared as Java class variables with special annotations, similarly to controls in a plain JWS file. E.g.:

/**
* @jws:control
*/
OrderProcessor orderService;

Actions

An action can be one of the basic building blocks of a process. An action can represent an atomic invocation of an operation on a control, or an invocation of local Java code. There can be at least four kinds of operations, such as:
incoming—the control or the “client” can call the workflow and not expect a reply or callback
outgoing—the workflow can call the control and not expect a reply
request/response—the workflow can call the control and expect a synchronous reply
solicit/response—the control or the “client” can call the workflow and expect a synchronous reply
   Since JWS already provides a way to handle operation invocations and callbacks, the significance of the action construct is not to provide an additional way to do the same thing. The added value of an action construct can include the ability to allow a developer sequence, as well as to parallelize operation invocations and callbacks. Workflows can handle operations including incoming, outgoing, and request/response operations. Solicit/response type operations may not be handled by workflows, as there is no way for a workflow engine to properly sequence out-of-bound requests in this case since the invoker expects a quick, or synchronous, reply.

There can be at least two elements in a workflow language for actions, including receive and perform elements. Both of these elements can reference Java methods inside a JWF file that carry out work related to the action. A receive action can mark the receipt of a message that comes either via the workflow's primary interface, such as from a “client,” or from a control as a callback operation. A method attribute can be used to identify the Java method that handles the message. The workflow engine may store the message before invoking the Java handler function in case the message arrives at a time when the workflow is not ready to receive the message, according to the flow logic.

In one example of using a receive tag, the workflow declares a receive action for a message from the “client”:

```
<receive name=“Receive PO” method=“getPO”/>
...
  void getPO(XML po) {
    inputPo = po;
  }
```

In a second example, the receive action is used to mark a callback operation from a control. The method attribute of <receive> references a Java method that is defined to handle the callback operation from the control.

```
<receive name=“Handle service ack.”
      method=“orderService_sendAck”/>
...
  private void orderService_sendAck(XML ackedLine)
    throws Exception {
      poAckList = myQueries.concat(poAckList, ackedLine);
  }
```

WSDL Interface of the Workflow

A WSDL interface of a workflow can be defined by non-control callback handler methods referenced by <receive> nodes, as well as the operation on the Callback interface. The exact shape of each operation can be determined in one embodiment as follows:
If the operation is a normal Java method, then the same rules can apply as for JWS, i.e. the type of the message part of the corresponding WSDL operation can be auto-generated from the Java signature. A notable exception can include the situation where there is jws:wsdl annotation on the class that defines all operations of the JWS.

Another provision can include the ability to define message parts in an annotation above the operation. This can be allowed, in one instance, only when all parameters and the return type of the method are of the XML type. E.g.:

```
/**
  * @jws:operation
  * @jws:schema import=“myschema.xsd”
  * @jws:return-xml schema=“mytype1”
  * @jws:parameter-xml schema=“mytype2”
  **/
  XML foo(XML body)
```

This example defines the output message to be mytype1 and the input message to be mytype2 respectively. The schema annotation references the schema file, where these types and element are defined.
Perform

A perform tag can be used to tell the workflow engine to execute a “black box” Java operation that is identified by the method attribute of the tag. E.g.:

```
<perform name=“Send reply to the client” method=“sendReply”/>
... /**
    * @jwf:transforms
    */
    POTransforms transforms;
  public void sendReply( ) {
    callback.reply(transforms.buildReply(poAckList));
  }
```

Starting Workflows

Workflows can be started by messages. The first activity in a workflow, such as the first child of the process tag, can be either a <receive> or a <multiReceive>. When a client invokes such an operation, a workflow instance can be started. When <multiReceive> is defined, <multiReceive > can be the first activity as well, in order to support multiple ways of starting the same workflow.

A special case of message-started workflows can involve a message broker starting a workflow as a result of a subscription. The subscription parameters can be defined by annotating the JWS operation that is invoked by the message broker, such as when the broker delivers the message. E.g.:

```
/**
  * @jws:mb-static-subscription message-topic-name=“myapp.POAck”
  * filter-name=“myFilter”
  * filter-value-match=“myvalue”
  * filter-body=“msgbody”
  **/
  void foo(XML msg)
```

The jws:mb-static-subcription annotation can be used to specify the subscription parameters, such as the kind of messages that cause the message broker to start a workflow of this kind.
Decision

A decision node or activity can be used to select exactly one path of execution based on the evaluation of one or more conditions. When on a <decision> node, the workflow engine can evaluate the conditions on the enclosed <if> nodes. Execution can continue with activities inside the first <if> node, with a true condition. An optional enclosed <default> node can be executed if no other conditions are met. In the example below, the PO is approved by different people depending on the amount:

```
<decision name=“Check amount>
        <if condition=“vpApproval” parameters=“po”>
                <perform name=“assign approval to VP” .../>
        </if>
        <if condition=“mgrApproval” parameters=“po”>
                <perform name=“assign approval to director” .../>
        </if>
        <default>
                <perform name=“assign approval to mgr” .../>
        </default>
</decision>
...
xquery::
  define function vpApproval(element $po) returns xs:boolean {
      return $po/amount/text( ) > 5000
  }
  define function dirApproval(element $po) returns xs:boolean {
      return $po/amount/text( ) > 1000
  }
```

The condition attribute can contain a reference to a Java operation that returns boolean. The Java operation can be locally in the JWF file, can be an inlined XQuery function. If the referenced condition is an inlined XQuery function, a parameters attribute can specify the workflow variable(s) to be passed into the function identified. Multiple variables can be separated by spaces. String constants can be passed in enclosed by a single quotation mark. E.g.:
<if condition=“checkCo”parameters=“lineitem,‘IBM’”>
Switch

A <switch> node can be used to select one path of execution, based on the value of a single expression that is associated with the node. When on a <switch> node, the workflow engine can first execute the expression, then compare the result to the values associated with the <case> nodes inside the <switch>. Execution can continue with activities inside the first <case>, with a matching value. An optional enclosed <default> node can be executed if no other conditions are met.

```
<switch name=“where to send” expression=“getProduct”
parameters=“po”>
  <case value=“widgetA”>
    . <perform name=“order widgetA” handler=“orderA”/>
  </case>
  <case value=“widgetB”>
    . <perform name=“order widgetB” handler=“orderB”/>
  </case>
  <default>
    <perform name=“throw on unknown product” .../>
  </default>
</switch>
xquery::
  define function getProduct(element $po) returns string {
      return $po/product-name }
```

MultiReceive

A <multiReceive> activity can provide a way to wait on multiple input events simultaneously, and to proceed on a particular branch of execution, based on which event occurred first. The children of <multiReceive> can all be <onMessage> elements. Each <onMessage> can represent an input event, as well as a branch of execution that should be taken, provided that the input event of the <onMessage> occurred first inside the enclosing <multiReceive>. The input event can be represented by a <receive> action, which can be the first activity or tag inside <onMessage> . The activities after <receive> can be the activities that are executed subsequent to the event selection. All <onMessage> tags can contain different input events. The workflow compiler can flag an error if <receive> tags referring to the same Java method appear as input events inside <multiReceive>. The same can be done for <parallel>. In addition to <onMessage>, <multiReceive> can have a single <onTimeout> sub-element as well, which can cause the workflow engine to generate special timeout event that is considered alongside with the regular input events.

Due to the serial nature of the workflow container, there may never be a race condition between input events. Events can be delivered one at a time to the entity bean that represents the workflow. Once the first matching event of <multiReceive> has been delivered to a workflow instance, the other input events that are potentially delivered later can be discarded, unless they are referenced later in the workflow.

In the example below, the workflow uses the <multiReceive> activity to wait for a callback from a “backend” control, a cancellation message from the client of the workflow, or for a timeout of 10 seconds. The condition or event that happens first will determine the flow of execution. In case the callback comes first, the workflow can send a message to the client, which can be referred to as the “normal” path of execution. If a “cancel” message from the workflow client arrives first, the next activity after <multiReceive> can be performed:

```
<multiReceive>
  <onMessage>
    <receive  name=“get  availability”
method=“backend_getAvailability”/>
    <perform name=“send reply to client” method=“sendReply”/>
  </onMessage>
  <onMessage>
    <receive name=“get cancellation” method=“cancel”/>
  </onMessage>
  <onTimeout duration=“P10S”>
    <perform name=“send error to the client” method=“sendError”/>
  </onTimeout>
</multiReceive>
<done/>
/**
* @jws:control
**/
BackendWS backend;
void backend_getAvailability(XML msg) {...}
/**
* @jws:operation
**/
void cancel() {...}
void sendReply() {...}
void sendError() {...}
```

forEach

A forEach activity can perform a set of activities repeatedly, such as once for each item in a list. For instance, the example below defines a forEach activity to iterate through the line items of a purchase order.

```
  <forEach variable=“lineitem”
      expression=“ getLineItems”
      parameters=“inputPO”>
    <perform name=“processLine” method=“processOrder”/>
    <receive name=“gotAck” method=“orderService_sendAck”/>
  </forEach>
...
xquery::
  define function getLineItems(element $po) returns element* {
  return $po/DATAAREA/PROCESS_PO/POORDERLIN }
::
```

The expression attribute can point to a method whose return type is java.util.Iterator, or to an inlined XQuery function. The variable attribute can reference a workflow variable where the current item of the iteration is stored. The parameters attribute can specify the workflow variable(s) to be passed to the Java operation, identified by the expression attribute. The format can be similar to the parameters attribute of <switch> .

doWhile and whileDo (loop)

A <whileDo> activity can perform the enclosed activities repeatedly, as long as the loop condition is true. The loop condition can be defined by the condition attribute of <whileDo>. This condition can be evaluated before the enclosed activities are performed, such as the activities inside <doWhile> being performed zero or many times. Similar to <switch>, the condition attribute can contain a reference to a Java operation that returns boolean. The Java operation can be locally in a JWF file, or can be an inlined XQuery function. The parameters attribute can specify the workflow variable(s) to be passed in to the Java operation, identified by a condition attribute. Multiple variables can be separated by spaces, and string constants can be passed that are enclosed by a single quotation mark.

In the example below, the “receive line item” action is executed as long as the “lastLine” attribute is not present in the XML document held in the lineItem variable:

```
<receive name=“receive line item” method=“getLineItem”/>
<whileDo condition=“notLast” parameters=“lineItem”>
<receive name=“receive line item” method=“getLineItem”/>
<whileDo/>
...
/**
  * xquery::
      * define function notLast(element $po) returns boolean {
      * return empty($po/@lastLine) }
      *::
      */
    ...
/**
  * @jws:operation
  */
void getLineItem(XML x) {
  lineItem = x;
}
```

<doWhile> can be similar to <whileDo>, except that the loop condition is checked after the activities have been performed. So, the activities inside <doWhile> are performed one or many times. Below is the —modified—example that uses <doWhile> instead of <whileDo>:

<doWhile condition=“notLast” parameters=“lineItem”>
<receive name=“receive line item” method=“getLineItem”/>
<do While/>

Parallel

A majority of mainstream programming languages does not offer high-level abstractions for parallel execution. Writing parallel programs remains a tricky task, which can require the mastering of low-level APIs and a deep understanding of the underlying execution model. Users still can require parallel execution to increase throughput by performing tasks in parallel that are not dependent on each other. There are at least two typical cases, where parallelism helps:
Complex computations, such as matrix multiplication, where the algorithm can easily be broken into multiple independent parts. In the matrix multiplication case each element of the resultant can be computed separately, which can allow for massive parallelization.
Programs including long waits on an external resource. For example, if a program reads data from a file and then from the network, these items can be processed in parallel, such that the network read does not wait due to potential disk I/O time caused by the file read.
   Workflows can be capable of utilizing the benefits of parallelism, due at least in part to the second item above. Workflows often communicate with external systems that are slow to react, so breaking up message exchanges with different systems into multiple paths of execution can be advantageous.
   Parallelism Challenges

While parallel execution can bring some clear benefits, such execution can also cause additional problems for a programmer. One such problem centers on accessing shared state from multiple threads of execution. Since the threads can be part of a larger programming unit, mutual exclusion in the threads' access to shared state, such as global variables, can be a problem. A second challenge can involve synchronizing the execution of multiple threads. This can range from the simple ability to wait for termination of several threads to complexity of arbitrary inter-thread communication. High-level programming languages can contain abstractions to handle both challenges. The “synchronized” keyword in Java can be a mechanism to achieve mutual exclusion.

Workflows and Parallelism

As discussed above, workflows can utilize parallelism because of the common pattern that involves exchanging messages with multiple slow running systems. There can be certain important characteristics to parallel patterns in workflows:
The number of parallel branches is small (2-3).
The cross-traffic between parallel branches can be minimal, typically no shared variables and only simple synchronization: wait for termination of multiple branches.
In existing products, developers often use parallel branches of workflow to handle exceptional cases: a branch is dedicated to just waiting on a message that is only received in exceptional cases, such as a “cancel” message. In systems and methods in accordance with the present invention, there will be no need to use parallelism to handle this, as an exception handling mechanism can be used instead.
   Additionally, an EJB container can serialize execution of workflow steps. What may appear to be parallel branches can in fact be only “logically” parallel, as physically the branches are going to be executed serially.
   Language Syntax

A <parallel> tag can define a complex activity that consists of a number of <branch> activities, each representing parallel branches of execution. Activities that make up a branch can be placed inside a <branch> tag. There can be several branches inside a single <parallel> tag, and nesting of <parallel> tags can be supported.

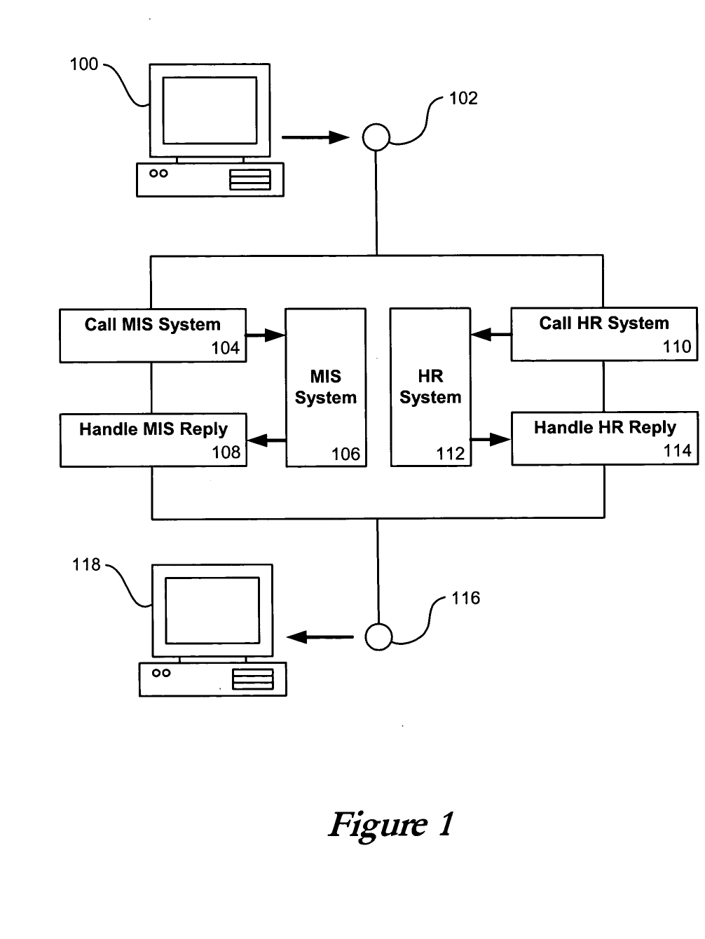

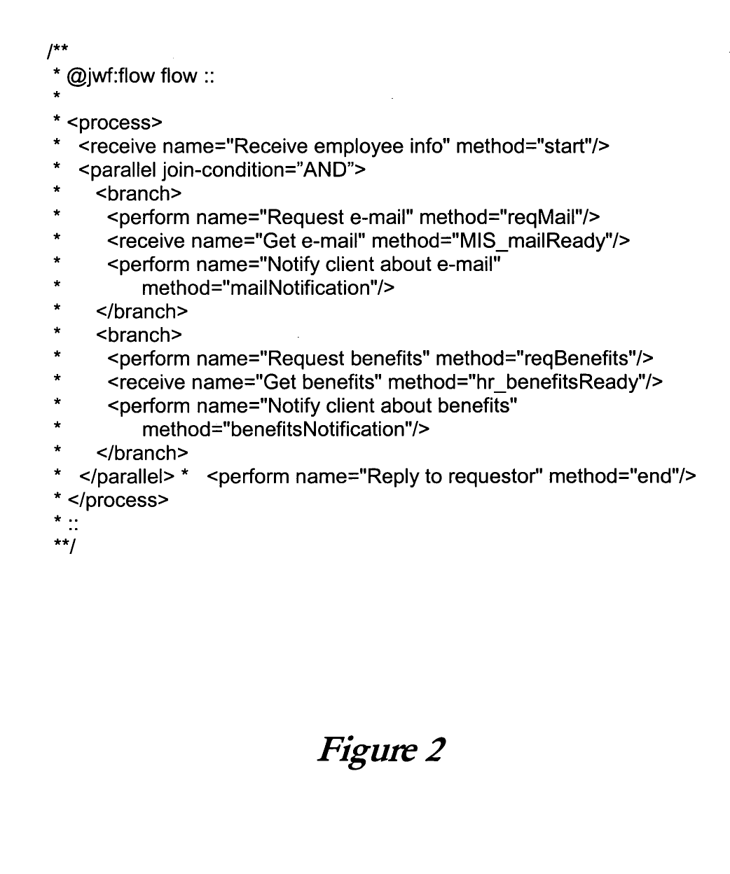

For example, a “New Employee” workflow can be run every time somebody starts with the company. The HR system can be notified to get benefits arranged for the person, and the MIS web service can be invoked to enter an email address for the new employee. These systems can be loosely coupled both from each other and from the orchestrating workflow, so the flow sends them a message first with the request and they asynchronously reply, once they carried out their respective tasks. At that point the workflow can reply to the invoker that “initialization” of the employee is done. FIG. 1 shows a graphical view of the use case, as the developer might draw it. Input device 100 is coupled to workflow node 102 that starts the workflow which branches into notifying MIS System 106 and HR System 112. The MIS System 106 notifying branch consists of the activities Call MIS System 104 and Handle MIS Reply 108. The HR System 112 notifying branch consists of the activities Call HR System 110 and Handle HR Reply 114. The workflow after handling the MIS Reply 108 and HR Reply 114 finishes at the node 116 which is coupled to processing device 118. The flow language for this use case can look as shown in FIG. 2. Each branch can have access to all workflow variables at all times. In order to avoid potential problems, is can be desirable in certain systems to name global variables according to their association with a branch.

The only synchronization point between branches can be their termination point. There may be no mechanism for the branches to synchronize with each other in the middle of their execution. A join-condition attribute of a <parallel> tag can specify how branch termination can cause termination of the <parallel> activity itself. The attribute can have at least two values, including AND and OR. If the join-condition attribute is set to AND, the <parallel> activity can terminate once all of its <branch> activities have terminated. If the join-condition is set to OR, the <parallel> activity can terminate once one of its <branch> activities has terminated. Other active branches can be terminated prematurely. Since an EJB container can provide non pre-emptive scheduling of the branches, all other branches can be in a “wait” state, blocking on a <receive>, when one of the branches terminates.

Using Composition

One way to achieve mutual exclusion of variables and complex synchronization between branches is to package up the flow of the branch into a separate workflow and call that workflow as a control from the branch:

/**
* @jwf:flow flow ::
*
* <process>
* <parallel>
* <branch>
* <perform name=“start subflow 1” method=“startBranch1”/>
* <receive name=“wait for subflow 1 to end” method=“br1_end”/>
* </branch>
* <branch>
* <perform name=“start subflow 2” method=“startBranch2”/>
* <receive name=“wait for subflow 2 to end” method=“br2_end”/>
* </branch>
* </parallel>
* <perform name=“Reply to requestor” method=“end”/>
*</process>

| | |
|---|---|
| * | :: |
| **/ | |

This solution can achieve mutual exclusion of variable access, since the branches can execute as separate workflows, protected by separate EJB instances. Complex synchronization, such as rendezvous, may not be possible using such a solution.
Exception Handling

Workflow exceptions can include Java exceptions that are not caught by Java handler methods. These will be referred to herein as “system exceptions.” Examples of workflow exceptions can include:
Trying to use the JMS control, but the underlying JMS queue is not there.
The EJB called by the workflow throws an exception that is not handled by the Java handler code.
The web service called by the workflow is not reachable

An exception-handling block, or shortly block, is a piece of workflow that is enclosed inside an <block> element. For example:

```
<block onException=“handleIt”>
  <receive .../>
  <perform .../>
</block>
...
<exceptionHandlers>
  <exceptionHandler name=“handleIt”>
  <!-- actions -->
  </exceptionHandler>
</exceptionHandlers>
```

If an exception occurs inside the block, the engine can stop the normal flow of execution, and can execute the activities inside the exception handler pointed to by the onException attribute. Exception handlers are pieces of workflow that can be defined under the <exceptonHandlers> element. Exception handlers are named and can be scoped to the process. Blocks can also contain <onMessage> tags. The first child of an <onMessage> tag can be a <receive>. During the execution of activities contained inside a block, whenever a message arrives that is referenced by the <receive> tag inside <onMessage>, the workflow engine can switch to the activities inside <onMessage>.

Having performed the exception handler on an <onMessage> block, the workflow engine can execute the activities after the block. If the desired behavior is to terminate the workflow as a consequence of the exception, the exception handler can contain an abort activity. If there is no exception handler defined by the user, the engine can automatically handle the exception by simply freezing the workflow.

The exception handling behavior with respect to parallel branches can be somewhat different. Blocks may be unable to span multiple branches of <parallel>, but can contain a <parallel> block in its entirety or can just be constrained to a single branch. E.g., the following may be valid:

```
<block>
  <parallel>
    <branch>
    ...
    <branch/>
    <branch>
    ...
    <branch/>
  <parallel/>
</block>
```

If the block contains the whole <parallel> block, an exception can terminate all branches of parallel. If the block is constrained only to a single branch, then an exception occurring in that branch may not affect execution of other branches. An onException attribute on the process element can be supported that is equivalent to an implied <block> around the entire process. This can be a shorthand notation to cover perhaps 80% of the use cases. The Java exception that caused the last workflow exception can be retrieved using an operation such as a JwfContext.getException( ) operation. If no exception handler is specified, then <block> canbe a way to persist a grouping of several nodes together for the purposes of the workflow designer GUI.
Short Running Transactions

Workflow activities can be grouped to transaction blocks. Activities inside a transaction block can be executed inside a single JTA transaction:

```
<transaction>
  <receive name=“get PO from queue” .../>
  <perform name=“update log” .../>
  <perform name=“register PO with ERP EJB” .../>
</transaction>
```

In the above example the state of the workflow, including variables and a program counter, can be updated in the same JTA transaction as the resources that are accessed by the actions enclosed inside the <transaction>, including the message queue where the PO was read form, the log database, and finally the EJB front-ending the ERP system. If, for example, the write to the log database fails in the <perform> action, the PO message can remain in the queue.

A retryCount attribute of the <transaction> can specify how many times the workflow engine should retry to perform the activities inside the transaction. If all retry attempts have failed, the workflow engine can generate a workflow exception. Workflows can access resources via operations on controls. Some controls can support JTA transactions. If an operation on the control is called inside a JTA transaction, the work carried out inside the operation can be “infected” by the transaction. Examples of such “transactional controls” or “transactional operations” include the JMS control, the EJB control, and the DB control. The service control and its methods in general are not transactional, since the web services stack may not support transaction propagation. In case a service control operation is called via JMS “buffering”, the front-end of the call can become transactional. If a non-transactional operation is called inside a transaction block, the work inside the operation may not be included in the transaction. For instance, if the transaction is rolled back, the work that has been performed by the operation can remain unaffected.

Rules for the Shape of a Transaction Block

There are certain rules that should be observed when defining transaction blocks. These can include, for example:
a <receive> and <multiReceive> can only appear as the first activity inside a transaction block, as <receive> (and <multiReceive> ) can force a transaction boundary for the workflow context. Other types of activities can appear at any position.
transaction blocks cannot contain multiple branches of a <parallel>
   Implied Transaction Blocks

If a developer does not define transaction blocks, the workflow engine can separate its execution into transactional chunks according to a simple rule, such as a rule to commit the current transaction every time, when the next activity is a <receive>, <multiReceive>, or <parallel>. If the transaction blocks cover only part of the workflow, the workflow engine can apply this simple rule for the rest of the workflow, or the “uncovered” part.

Long-Running Transactions

Workflows may often perform long running activities that can last for hours or days. Due to the long duration, it may not be possible to enclose these long-running activities in a transaction block, which can be implemented using a short running JTA transaction. To ensure atomicity in long running workflows, the developer can define sagas. Similar to transaction blocks, sagas can contain activities. One key difference between sagas and transaction blocks can include the way that aborts are handled. For transaction blocks the resource managers involved in the underlying JTA transaction can automatically undo all the work that has been done since the beginning of the transaction. This can include possible changes in the workflow state, such as values stored in workflow variables. For sagas this may not be possible, since the resource managers may not understand sagas, or long-running transactions. Therefore there can be a need for another way of undoing work, referred to herein as compensation. A logical place to define compensations can be in the transaction blocks, since a transaction block by definition constitutes an atomic unit of work. Each transactional block inside a <saga> can have a compensating section, where the compensating activities for the transaction block can be placed. Compensation can be performed if any of the enclosed transaction blocks abort. For example:

```
<saga>
  <transaction>
      <receive .../>
      <perform .../>
      <compensation>
          <!-- perform for un-perform -->
        <perform .../>
      </compensation>
    </transaction>
    <transaction>
      <perform .../>
      <compensation>
          <!-- send for un-send -->
          <perform .../>
      </compensation>
    </transaction>
  </saga>
```

For sections that are not inside a transaction block, no special compensation will be done. E.g.:

```
<saga>
  <transaction>
    <receive .../>
    <perform .../>
    <compensation>
      <!-- perform for un-perform -->
      <perform .../>
    </compensation>
  </transaction>
  <perform ../>
</saga>
```

For the <perform> in the above example, no compensating action may be invoked. The compensation blocks can be performed in reverse order relative to the original execution, with the last transaction block to commit being compensated first. Compensations for transaction blocks that have been defined on parallel branches can be executed in parallel. Each compensation block can be started in a separate JTA, or short running, transaction. Compensations may not include sagas. If a workflow fails with an unhandled exception during compensation, the engine can freeze the workflow such that manual intervention from an administrator can be required.

### EXAMPLES

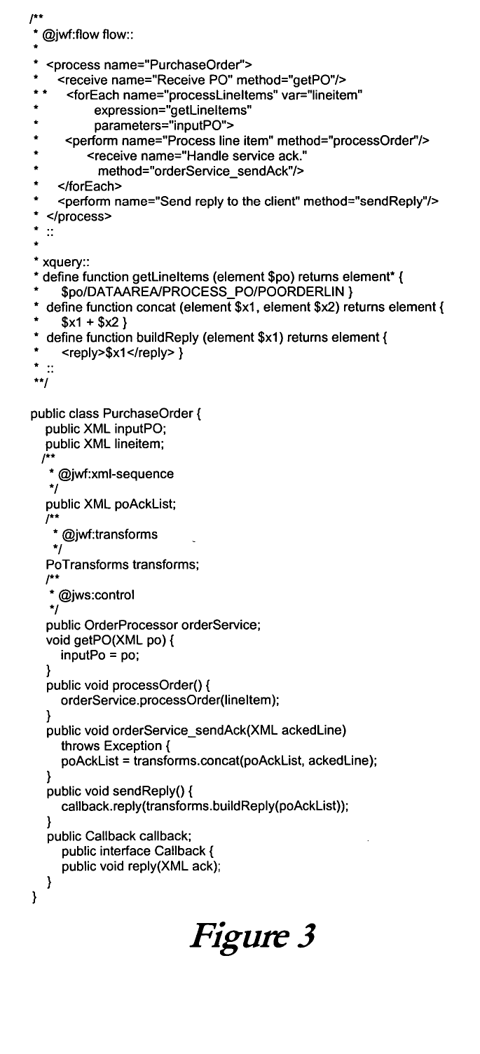

In one example that can be used in accordance with embodiments of the present invention, the scenario involves passing in a PO to start a workflow. The workflow iterates over the line items in the PO. For each item, the workflow sends a request to a backend system. The request to the backend system includes part of the PO plus the individual line items. The replies are gathered, concatenated into a PO Acknowledgement, and sent back to the client. An example of this JWF is shown in FIG. 3.

In another example, a business process can be created to handle purchase orders. A workflow can expose a SOAP operation that accepts a purchase order asynchronously, places orders for the line items contained in the purchase order, and respond to the requestor with a purchase order reply message by performing a SOAP callback. The process can use a JWF forEach loop construct to iterate over the set of line items in the purchase order. In the underlying JWF file for the business process, the incoming purchase order is stored in an XML workflow variable and an XQuery expression is used to control the looping by enumerating each line item in turn from within the XML purchase order variable. Inside the loop, a web service call can be made to send the line item to a backend order management system, and the response can come back in the form of a web service callback. JWF can include constructs to specify such flow actions as message sending and receiving, looping, conditional branching, parallel execution, waiting for one of a possible set of messages, Java method invocations, and transaction and exception handling.

The line item callbacks can take a large amount of time to occur, such as hours or even days depending on the nature of the backend system. Another benefit is that the flow language can enable such applications to be easily constructed by corporate developers. A JWF runtime container can use transactions and queuing to reliably execute, sequence, and recover the individual Java- and/or XQuery-based workflow steps, it can handle call/callback correlation, and it can enable the application to be deactivated, such as by utilizing entity beans and persistent storage, during long periods of inactivity, even in the midst of loops in the flow. The flow description can indicate the types of messages expected by the workflow, and when those messages are expected, which can differ from the order of receipt.

Element Definitions

Process
   <process name=QName onException=>
   Content: {any activity}*
   name: the GUI label for the process
   onException: the process wide exception handler
exceptionHandlers
   <exceptionHandlers>
   Content: <exceptionHandler>+
exceptionHandler
   <exceptionHandler name=>
   Content: {any activity}*
   name: the name of this handler, referenced by <process> or <block> exceptionHandler cannot contain <transaction>.
done
   <done/>
   Content: empty
receive
   <receive name=QName method=QName/>
   Content: empty
   name: the GUI label for the action
   method: points to a Java operation inside the JWF file that will either be exposed as a client operation, or it is a control callback handler
perform
   <perform name=QName handler=QName/>
   Content: empty
   name: the GUI label for the action
   method: points to a Java operation inside the JWF file
decision
   <decision name=QName>
   Content: <if>+
   <if condition=parameters=>
   Content: {any activity}*
   condition: refers to a Java or to an inlined XQuery operation that returns boolean.
   parameters: a comma separated list of workflow variables and constants to pass to the Java operation, identified by the condition attribute. Constants must be in single quotes.
switch
   <switch name=expression=parameters=.>
   Content <case>+
   <case value=>
   Content: {any activity}*
   name: descriptive name for the switch node
   expression: refers to a Java or to an inlined XQuery operation (via jwf:queries) that returns a Java primitive type (String included) or a XML Schema simple type equivalent.
   value: a constant or a Java method, whose (return) type matches the type of the expression attribute
multiReceive
   <multiReceive>
   Content: <onMessage>+[<onTimeout>]
OnMessage
   <onMessage>
   Content: <receive>{any activity}*
onTimeout
   <onTimeout duration=>
   Content: {any activity}*
   duration: specifies how soon from the time the <choice> activity gets scheduled should
   a timeout event be raised. Uses the XML Schema “duration” data type.
forEach
   <forEach expression=variable=parameters=>
   Content: {any activity}*
   expression: an inlined Xquery function or a Java operation, which returns java.util.Iterator
   variable: the variable to hold the value of the current iteration
   parameters: a comma separated list of workflow variables and constants to pass to the Java operation, identified by the expression attribute. Constants must be in single quotes.
parallel
   <parallel join-condition=>
   Content: <branch>+
   join-condition: defines when does the parallel activity terminate. If it is set to OR, the parallel activity terminates, when the first branch has terminated. If it is set to AND, the parallel activity terminates, when all the branches have been terminated.
branch
   <branch>
   Content: {any activity}*
doWhile
   <DoWhile condition=parameters>
   Content: {any activity}*
   condition: refers to a Java operation or an inlined XQuery function that return a boolean. In the latter case the class name should include the full package name.
   parameters: a comma separated list of workflow variables and constants to pass to the Java operation, identified by the condition attribute. Constants must be in single quotes.
whileDo
   <whileDo condition=parameters>
   Content: {any activity}*
   condition: refers to a Java operation or operation on an inlined XQuery function that return a boolean. In the latter case the class name should include the full package name.
   parameters: a comma separated list of workflow variables and constants to pass to the Java operation, identified by the condition attribute. Constants must be in single quotes.
block
   <block onException=>
   Content: <onMessage>* {any activity}*
   onException: the exception handlers
onMessage
   Content: <receive>{any activity}*
transaction
   <transaction timeout=retryCount=>
   Content: {any activity}+[<compensate>]
   Another <transaction> cannot be nested inside.
   timeout: the JTA transaction timeout
   retryCount: the transaction will be retried this many times
compensate
   <compensate>
   Content: {any activity}+
   Cannot contain any <saga> elements.
saga
   <saga>
   Content: {any activity}+
      Business Processes

One example of a workflow language application is a workflow language for a business process manager (BPM) component. This workflow language (WFL) can define the processing rules of workflows that are executed by the BPM. The WFL can use a format such as XML format, wherein all WFL constructs are expressed as XML elements and attributes.

The foregoing description of preferred embodiments of the present invention has been provided for the purposes of illustration and description. It is not intended to be exhaustive or to limit the invention to the precise forms disclosed. Many modifications and variations will be apparent to one of ordinary skill in the art. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the following claims and their equivalence.

1. A method for creating a workflow language, comprising the steps of:
selecting an existing programming language; and,
extending said existing programming language by adding workflow constructs to the existing language.

2. A method according to claim 1, wherein:
the step of extending said existing programming language by adding workflow constructs further comprises embedding constructs defined by a second language in the existing programming language.

3. A method according to claim 1, wherein:
the workflow constructs are selected from the group consisting of parallelism, asynchrony, loops over asynchronous events, and flexible language handling.

4. A method according to claim 1, wherein:
the existing programming language is Java.

5. A method according to claim 2, wherein:
the second language is XML.

6. A method according to claim 1, further comprising:
allowing a user to define a virtual program with the extended programming language.

7. A method for utilizing a workflow language, comprising:
creating a workflow definition using a workflow language, wherein the workflow language comprises existing programming language extended with workflow constructs defined by a second language.
creating a workflow program comprising of said workflow definition.

8. A method according to claim 7, wherein:
said workflow definition is added to an annotation of the workflow program.

9. A method according to claim 7, wherein:
said workflow definition further comprises flow logic that references the variables of the workflow program.

10. A method according to claim 7, wherein:
said workflow definition further comprises flow logic that references the methods of said workflow program.

11. A method according to claim 7, further comprising:
providing ability for said workflow program to go dormant; and,
providing ability to revive said dormant workflow program to the exact state the workflow program was in before going dormant.

12. A computer-readable medium, comprising:
an existing programming language; and
means for extending said existing programming language by adding workflow constructs defined by a second language to said existing programming language.

13. A computer program product for execution by a server computer for creating a workflow language, comprising:
an existing programming language; and
computer code for extending an existing programming language by adding workflow constructs defined by a second language to the existing programming language.

14. A system for creating a workflow language, comprising:
an existing programming language; and
means for extending an existing programming language by adding workflow constructs defined by a second language to the existing programming language.

15. A computer system comprising:
a processor;
object code executed by said processor, said object code configured to:
extend an existing programming language by adding workflow constructs defined by a second language to said existing programming language.

16. A computer data signal embodied in a transmission medium, comprising:
a code segment including instructions to extend an existing programming language by adding workflow constructs defined by a second language to the existing programming language.

17. A system for handling the ordering of messages received in a program using a workflow language, comprising:
a workflow language comprising of looping construct with ordering of messages received defined by a second language added to an existing programming language;
a program written using said workflow language; and,
a workflow container to handle ordering of said messages received in said program.

18. A system for utilizing a workflow language, comprising:
a workflow definition created using a workflow language, wherein said workflow language comprises existing programming language extended with workflow constructs defined by a second language; and,
means for creating a workflow program comprising of said workflow definition.

19. A system according to claim 18, further comprising:
means for providing ability for said workflow program to go dormant; and,
means for providing ability to revive said dormant workflow program to exact state the program was in before going dormant.

20. A system according to claim 18, wherein:
said workflow definition is added to an annotation of said workflow program.

21. A system according to claim 20, wherein:
said workflow definition further comprises flow logic that references the variables of said workflow program.

22. A system according to claim 20, wherein:
said workflow definition further comprises flow logic that references the methods of said workflow program.

23. A method for creating a workflow language, comprising the steps of:
selecting Java programming language; and,
extending said Java programming language by adding workflow constructs to said Java programming language, wherein said extending further comprises embedding said workflow constructs defined by XML in the Java programming language.

24. A system for creating a workflow language, comprising:
Java programming language; and,
means for extending said Java programming language by adding workflow constructs to said Java programming language, wherein said extending further comprises embedding said workflow constructs defined by XML in the Java programming language.

25. A system for utilizing a workflow language, comprising:
a workflow definition created using a workflow language, wherein said workflow language comprises existing programming language extended with workflow constructs defined by a second language;
a workflow program comprising of said workflow definition; and
a workflow engine executing said workflow program.

26. A method for utilizing a workflow language, comprising:
creating a workflow definition using a workflow language, wherein said workflow language comprises existing programming language extended with workflow constructs defined by a second language; and
creating a workflow program comprising of said workflow definition.

27. A method for utilizing a workflow language, comprising:
selecting a workflow definition created using a workflow language, wherein said workflow language comprises existing programming language extended with workflow constructs defined by a second language; and
using a workflow program comprising of said workflow definition.

28. A computer program product created utilizing a workflow language, comprising:
a workflow definition created using a workflow language, wherein said workflow language comprises existing programming language extended with workflow constructs defined by a second language; and
a workflow program comprising of said workflow definition.
